(19) United States
(12) Patent Application Publication
(10) Pub. No.: US 2006/0247095 A1
(43) Pub. Date: Nov. 2, 2006

(54) Method and apparatus for promoting nerve regeneration in paralyzed patients

(76) Inventor: Patrick D. Rummerfield, O'Fallon, IL (US)

Correspondence Address: GALLOP, JOHNSON & NEUMAN, L.C., 101 S. HANLEY, SUITE 1600, ST. LOUIS, MO, 63105, US

(21) Appl. No.: 11/364,937

(22) Filed: Mar. 1, 2006

Related U.S. Application Data
(63) Continuation-in-part of application No. 10/355,877, filed on Jan. 31, 2003, now abandoned.
Application No. 10/355,877 is a continuation-in-part of application No. 10/252,218, filed on Sep. 23, 2002, now abandoned.
(60) Provisional application No. 60/323,828, filed on Sep. 21, 2001.

(51) Int. Cl. A63B 15/02; A61H 1/02; A63B 22/00; A61H 1/00

(52) U.S. Cl. 482/1; 482/51; 482/57; 601/23

(57) ABSTRACT

In one aspect the present disclosure provides a method of rehabilitating a person who has suffered central nervous system damage including the steps of providing exercise equipment capable of exercising a person's limbs, providing functional electrical stimulation to the person's limbs to be exercised in order to operate the exercise equipment, increasing the level of functional electrical stimulation; decreasing a resistance provided by the exercise equipment or providing assistance to maintain an acceptable speed of the exercise equipment as the person's muscles tire; finally completely removing functional electrical stimulation to the person's limbs and providing assistance to maintain an acceptable speed of the exercise equipment; and continuing passive exercise of the person's limbs for a period of time greater than two minutes. Also provided are apparatuses to carry out the method.

### RELATED APPLICATIONS

This application is a continuation-in-part of prior application Ser. No. 10/355,877 filed Jan. 31, 2003, which claims priority to U.S. patent application Ser. No. 10/252,218 filed Sep. 23, 2002, which claims priority to U.S. Provisional Patent Application No. 60/323,828 filed Sep. 21, 2001.

### TECHNICAL FIELD

The present invention relates generally to a method and apparatus for the promotion of nerve regeneration in the central nervous system of paralyzed patients. More specifically, it relates to a method and apparatus that promotes nerve regeneration in the central nervous system by combining active and passive exercise of the patient's disabled limbs.

### BACKGROUND OF THE INVENTION

More than one-quarter of a million people in the United States currently have impaired use of their limbs due to traumatic injuries affecting their central nervous systems and many more than this from non traumatic injuries such as stroke, cerebral palsy and leukodystrophy. This impaired limb use and subsequent immobility, besides creating mental and physical challenges to the patient, also can generate muscular atrophy, loss of bone mineral content, decubitus ulcers, urinary tract infections, muscle spasticity, impaired circulation, and reduced heart and lung capacity.

In the past, exercise for paralyzed individuals consisted of moving the patient's limbs passively in order to avoid the problems of impaired limb use. Typically, a therapist would manipulate the patient's limbs manually. However, passive exercise does not induce as much blood flow or reduce muscle atrophy enough to fully avoid the problems associated with paralyzed limbs.

As a result, systems were developed that utilized functional electrical stimulation to stimulate motor nerves and directly induce the muscles in a paralyzed limb to contract in order to perform exercise. As these systems improved, active exercise became the preferred method of exercising a paralyzed patient's limbs.

However, active exercise using functional electrical stimulation is generally used only until the muscle becomes tired. After the muscle tires, conventionally therapy is concluded, and the muscle is allowed to rest. The patent to Petrofsky et al., U.S. Pat. No. 4,499,900, discloses the continued use of passive movement for a brief period after the muscles fatigue in order to prevent blood pooling or to provide a brief cool down period. We have unexpectedly discovered that continuing movement of the impaired limb using passive movement for a prolonged period after discontinuing functional electrical stimulation promotes nerve regeneration in the central nervous system of a patient with a neurological impairment. In order to continue movement of the limb after the muscles tire, functional electrical stimulation is reduced or discontinued and passive exercise is initiated. By passively moving the affected limbs by mechanical means afferent neural feedback continues to be delivered into the impaired central nervous system for the entire duration of therapy. Therapy duration is no longer determined by muscle fatigue so a therapeutically effective duration of activity can be provided at each therapy session. As a result, with prolonged treatment over many weeks or months, individuals with a central nervous system injury or illness are able to improve their neurological condition. This improvement in neurological condition is in addition to the improvements in a patient's physical condition arising from the exercise effects of the active therapy.

### SUMMARY OF THE INVENTION

One aspect of the present invention provides a method of rehabilitating a person who has suffered central nervous system damage comprising the steps of providing exercise equipment capable of actively exercising a person's limbs utilizing functional electrical stimulation, initially increasing the level of functional electrical stimulation up to a desired maximum to achieve and maintain a given level or speed of exercise and then reducing the level of functional electrical stimulation as the person's muscles tire, decreasing a resistance provided by the exercise equipment or providing assistance to maintain an acceptable speed of the exercise equipment, and then completely removing functional electrical stimulation to the person's limbs and providing assistance to maintain an acceptable speed of the exercise equipment in a passive mode for the entire remaining duration of the therapy session.

Another aspect of the present invention provides a bicycle for exercising limbs of a paralyzed person for a desired therapeutically effective therapy period comprising a pair of pedals operable by the paralyzed person, a functional electrical stimulation controller for controlling the stimulation of the impaired limbs, and an electric motor for providing resistance or assistance to the pedals in order to maintain a desired pedal speed. The functional electrical stimulator provides functional electrical stimulation to muscles of the impaired limbs of the person with central nervous system damage in order to operate the pedals wherein the functional electrical stimulation controller is adapted for reducing the level of functional electrical stimulation as the muscles tire.

Another aspect of the present invention provides a gate trainer for simulating the act of walking for a patient. The gate trainer is operated by lifting a paralyzed patient in an overhead hoist (not shown) that supports the patient's torso and allows the patient's legs to be moved freely. Elliptical motion created by translational motion shafts is similar to the lifting and then stepping of a person's feet while walking.

### BRIEF DESCRIPTION OF THE DRAWINGS

FIG. 1 is a side view of a bicycle for a paralyzed patient according to an embodiment of the present invention;

FIG. 2 is a side view of a gate trainer for a paralyzed patient according to an embodiment of the present invention;

FIG. 3 is a perspective view of a bicycle for a paralyzed patient according to a third embodiment of the present invention; and

FIG. 4 is a side view of a bicycle for a paralyzed patient according to an embodiment of the present invention.

### DETAILED DESCRIPTION OF THE PREFERRED EMBODIMENT

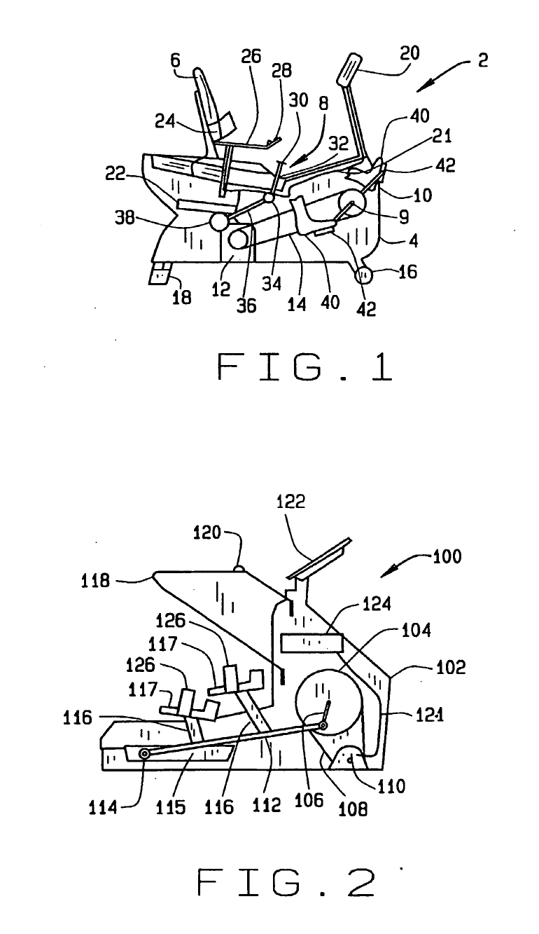

Referring to FIG. 1, there is provided an active/passive stimulation exercise trainer 2. The trainer 2 comprises a frame portion 4 to which is attached a seat 6, a pair of adjustable leg braces 8, a pulley or sprocket 9, crank arms 10 connected to the sprocket 9 and an electric motor 12 also connected to the sprocket 9 by a belt or chain 14. The frame portion 4 is maintained in an upright position by outwardly extending front and rear feet 16, 18. Also attached to the frame 4 is a bike control and readout (BCR) computer 20 attached to a functional electrical stimulation (FES) computer 22, the electric motor 12, and a control pad 28 by a cable 21. The FES computer 22 is a known device for electrical stimulation of muscles to induce organized contractions in order to move a patient's limbs. FES computers 22 are known and available from a variety of sources. The BCR computer 20 tracks stimulation current and cycle RPM and displays motor resistance, stimulation current, miles, total revolutions and RPM.

Attached to the seat 6 are a trunk support 24 and a seat belt (not shown) for providing additional support for a paralyzed patient. Also attached to the seat 6 and frame portion 4 is an armrest 26 and the control pad 28. The control pad 28 has an emergency stop button, a speed control dial or button and a start button. It is also contemplated that mounted to the control pad 28 or the BCR 20 is a microphone for receiving speech commands from the patient or therapist to be processed by the BCR computer 20 for controlling the trainer 2.

Each of the leg braces 8 has a leg support portion 30 attached to a first rod 32 that is extendable from a first clamp 34. Also attached to the first clamp 34 is a second rod 36 that is extendable from a second clamp 38. The second clamp is attached to the frame portion 4. By loosening the clamps 34, 38 and sliding the rods 32, 36 within the clamps 34, 38 and retightening the clamps 34, 38, the leg brace 8 can be adjusted to support patients of different sizes. Additionally it is contemplated that the seat 6 back can also be adjusted to support patients of different sizes. Finally boots 40 are attached to pedals 42 positioned on the ends of the crank arms 10 to fasten a patient's foot to the crank arms 10.

In operation, a paralyzed patient is seated on the chair 6 and is held by a seat belt. The patient's feet are attached to the boots 40 and the FES computer 22 is attached to the patient to begin electrical stimulation of the patient's muscles. Once FES begins, the patient's muscles begin to rotate the crank arms 10. The rotating crank 10, in turn, rotates the electric motor 12 through the chain 14. Initially, the motor 12 may operate to provide zero resistance to the patient's movement or it may operate in a brake mode in order to provide resistance to the patient's muscles. The BCR computer 20 monitors the motor 12 rotation speed and controls the brake force of the motor 12 to maintain a desired RPM. As the patient's muscles begin to tire, less brake force will be required to maintain the desired RPM until, at some point, the motor 12 will switch from a brake mode to a motor mode whereby the motor 12 is providing the power required to either assist the tired muscles in rotating the crank 10 (i.e. with full or reduced FES) or to continue rotating the crank 10 in the absence of assistance from the patient's muscles (i.e. in the absence of FES). The present invention utilizes passive exercise after FES is discontinued to cause central nervous system nerve regeneration in the patient.

Referring to FIG. 2, there is shown a gate trainer exercise machine 100. The gate trainer exercise machine 100 simulates the act of walking for a patient. To that end, there is provided a gate trainer frame 102 on which a flywheel 104 is mounted. Opposed crank arms 106 are attached to the flywheel 104. Connected to the flywheel 104 by a belt or chain 108 is an electric motor 110. First ends of two translational motion shafts 112 are connected to the crank arms 106 on either side of the flywheel 104. Rollers 114 are attached to the opposite ends of the translational motion shafts 112.

The gate trainer frame 102 defines two slots 115 on opposite sides of the frame 102 in which the rollers 114 are trapped. The rollers 114 move along the slots 115 in translational motion with the slots 115. Also attached to each translational motion shaft 112 is a foot support rod 116 and a foot support 117. A handrail 118 is attached to the gate trainer frame 102 and has a control pad 120 with an emergency stop button, a speed control dial or button and a start button. Also attached to the frame 102 is a gate trainer control and readout (GTCR) computer 122 that is attached to a FES computer 124, the electric motor 110, and the control pad 120 by a cable 121. The GTCR computer 122 tracks stimulation current and crank or motor RPM and displays motor resistance, stimulation current, miles, total revolutions and RPM.

It is also contemplated that each foot support 117 can be height-adjustable. This can be accomplished in numerous ways, for example by providing two telescoping rods having holes drilled therethrough in place of each foot support rod 116. To maintain the two telescoping rods in the proper relationship a pin can be inserted through the holes of the rods.

The gate trainer exercise machine 100 is operated by lifting a paralyzed patient in an overhead hoist (not shown) that supports the patient's torso and allows the patient's legs to be moved freely. The patient is placed over the foot supports 116 and the patient's feet are strapped to the foot supports 116 using foot straps 126. Once the patient is in position, the motor 110 begins rotating thereby turning the flywheel 104. The flywheel 104, in turn, rotates the crank arms 106. The rotational motion of the crank 106 is then converted to translational motion by the translational motion shafts 112 and the rolling of the rollers 114 within the slots 115. However, there is also an up-and-down motion to the translational motion shafts 112 as the translational motion shafts 112 rotate with the crank 106 using the rollers 114 as a center point. The elliptical motion created by the translational motion shafts 112 is thus similar to the lifting and then stepping of a person's feet while walking.

When the patient first begins using the gate trainer exercise machine 100, FES is used to stimulate the patient's muscles in order to cause the patient to simulate walking. The motor 110 is run in a brake mode to provide resistance to the elliptical walking motion of the patient's feet on the foot supports 117. As the patient's muscles begin to tire, the RPM of the motor 110 begins to slow and less brake force is applied by the motor in order to maintain the exercise. Eventually, as the patient's muscles reach a point beyond which they are too tired to continue, the motor 110 switches from brake mode to motor mode. Thus the treatment switches from an active exercise to a passive exercise. It has been found that, like above, passive exercise of the patient's affected limbs by mechanical means afferent neural feedback continues to be delivered into the impaired nervous system for the entire duration of therapy, thus rehabilitating the patient's central nervous system.

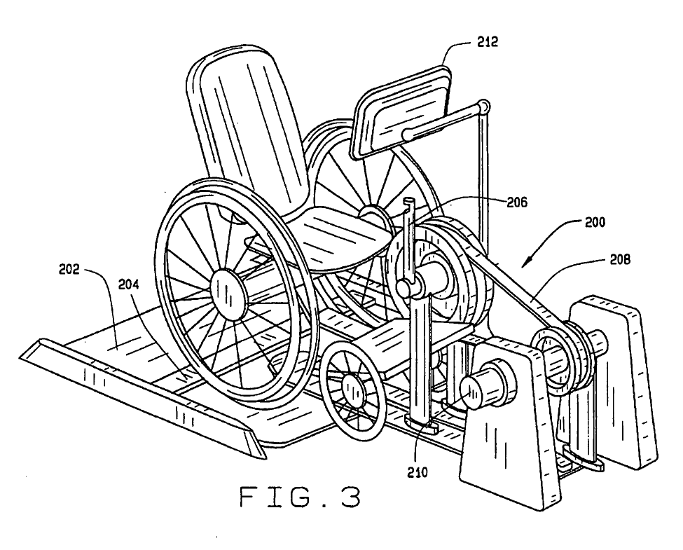

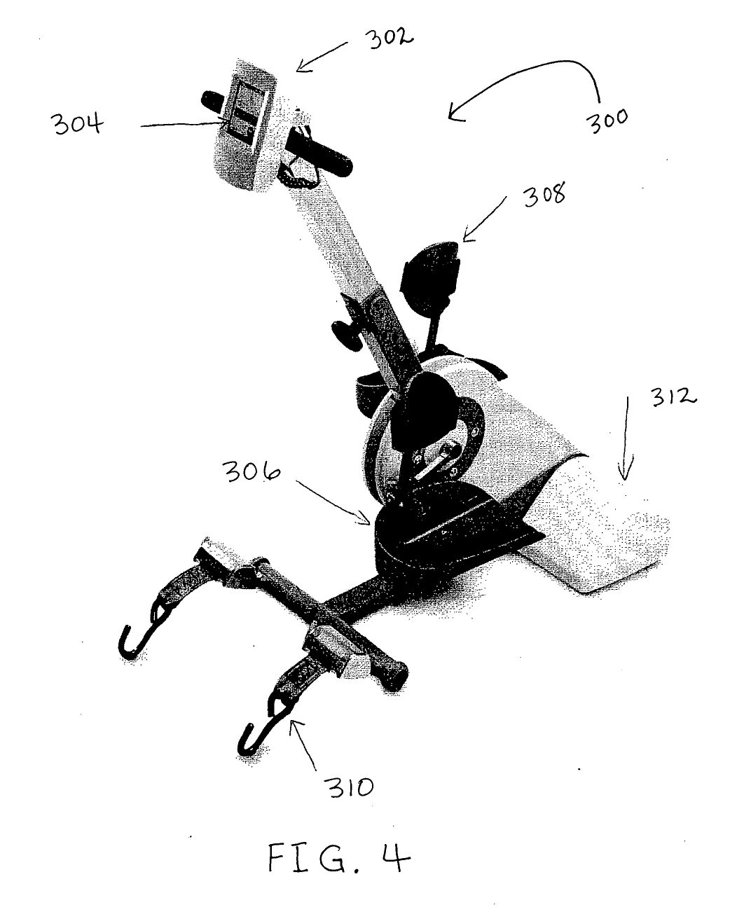

Referring to FIG. 3, there is shown and provided another embodiment 200 of the stationary bicycle of FIG. 1. This embodiment allows a person confined to a wheelchair to use the stationary bicycle 200 without being lifted from his or her wheelchair to a bicycle seat, thus allowing the person to administer therapy upon the bicycle without assistance from others, in the case of a paraplegic, or with greater ease and the assistance of fewer people in the case of a quadriplegic. The stationary bicycle 200 generally comprises a platform 202 having a wheel block 204. While not shown, the wheel block 204 may also be placed in front of the wheels of the wheel chair. The wheel block 204 is adjusted to the proper location to accommodate the leg length of the user to assist the wheel locks of the user to hold the wheelchair stationary while the user pedals the bicycle 200.

The bicycle 200 further comprises pedals 206, a chain or belt 208, and a generator/motor 210 as in the first embodiment. As in the first embodiment, the user's muscles are stimulated through FES and as the muscles tire, rotation of the pedals is tapered or switched from active to passive exercise in order to move the individual's limbs. Further, there is shown a screen 212 through which a user or the user's assistant may communicate with a computer (not shown) for controlling the bicycle. The computer allows the logging of data, such as quantity of muscle action, allows the use of a digital camera to communicate with a therapist at a remote location through a telecommunication link (such as the Internet), indicate upon the screen how the patient is progressing within the therapy or progress between therapies, transmit progress data regarding the patient's progress and activity to a therapist at a remote location, and allow the user to contact an Internet portal for others in a similar condition for communication, education and support. Furthermore, it is further contemplated that a virtual image of the user could be displayed on the screen showing the user pedaling the bicycle in a virtual location. For example, the user could be shown bicycling down a mountain pass in the Tour de France or taking a leisurely ride on a nature path. It is contemplated that such virtual images could provide motivation and entertainment for users while their limbs are being exercised. It is further contemplated that the control computer may implement voice recognition software to accept commands to allow the user to control the bicycle 200 without the need to physically touch buttons. Finally, it is contemplated that the computer would implement a personal computer operating system to allow the user to perform the function of a personal computer, such as surfing the Internet, writing email, drafting letters, playing games and tracking personal finances while the user's limbs are being exercised.

Referring to FIG. 4, there is shown and provided another embodiment 300 of the stationary bicycle in FIG. 1. In this embodiment, the controller and stimulator system are housed together 302. The controller includes a touch sensitive display 304 making it usable by patients with reduced hand function. The embodiment 300 also has a foot restraining pedal 306. Mounted to the pedal 306 is a calf support 308, which is designed to restrain the leg so that it moves in the plane of pedal rotation. Restraints 310 are attached to the patient's wheelchair or other chair to provide stabilization and prevent movement of the chair. The motor 312 is linked to the pedal crank by a drive belt. The motor 312 can apply torque to drive the pedals 306 or provide resistance against which the patient can cycle for enhanced exercise effects. The motor 312 is controlled by the combined controller and simulator system 302. The combined controller and simulator system 302 coordinates the operation of the motor 312 with the functional electrical stimulation system so that a patient can undergo a duration of therapy that is therapeutically effective. Preferably the combined controller and simulator system 302 utilizes active therapy whereby the patient's muscles do the work required to rotate the crank, however if this is not possible due to fatigue or muscle weakness, the therapy session continues utilizing power supplied by the motor 312 so that the patient achieves the required duration session and consequent neurological benefits.

While machines have been shown and described that serve the purpose of rehabilitating a person's central nervous system for controlling the person's legs, the principles of the present invention apply equally to rehabilitating the central nervous system for controlling a person's arm or other muscles. For example the embodiment of FIG. 1 could be easily altered to allow rotation of crank 10 by a person's arms and hands. The embodiment of FIG. 1 also could be easily altered to allow elliptical rotation of a person's arms and hands.

Another aspect of the present invention provides a method for rehabilitating a person who has suffered central nervous system damage comprising the steps of providing exercise equipment capable of actively exercising a person's limbs utilizing FES, initially increasing the level of FES up to a desired maximum to achieve and maintain a given level or speed of exercise and then reducing the level of FES as the person's muscles tire, decreasing a resistance provided by the exercise equipment or providing assistance to maintain an acceptable speed of the exercise equipment, and completely removing FES to the person's limbs and providing assistance to maintain an acceptable speed of the exercise equipment for the entire desired duration of the therapy session. In a preferred embodiment the exercise equipment is a bicycle for exercising limbs of a paralyzed person for a desired therapeutically effective therapy period comprising a pair of pedals operable by the paralyzed person, a functional electrical stimulation controller for stimulating the impaired limbs, the operation of which is integrated with an electric motor for providing resistance or assistance to the pedals in order to maintain a desired pedal speed. The electric motor is initially used to bring the pedals and impaired limbs to a desired speed. The functional electrical stimulator then applies stimulation to the impaired limbs, up to a set maximum level, to achieve a desired level of exercise or cycling speed. Once the FES reaches the maximum level and the muscles continue to fatigue the level or speed of exercise will decrease. At this point either:

1. The FES is decreased or removed and the exercise is continued passively under the power of the electric motor such that the movement of the impaired limb continues for the entire therapy period OR

2. The FES is continued for a further set period during which the electric motor assists the cycling motion to maintain a minimum speed such that the movement of the impaired limb continues for the entire therapy period. After any preset period, this operation may switch to that described in point 1 above. At the conclusion of the desired therapy period, in all cases the FES is removed and the exercise is continued briefly, typically 30 seconds to 2 minutes, in order to provide a cool down period. After this period the electric motor is switched off and the therapy session is concluded.

In the preferred embodiment of the method for promoting nerve regeneration in paralyzed patients, the impaired limb continues movement by using a passive stimulus after discontinuing FES for a prolonged period. Passive movement is continued so that the impaired limb undergoes a total of at least an hour of movement per therapy session. In a preferred embodiment the desired overall therapy period is about one hour and the passive exercise of the person's limbs are continued for a period of time greater than 2 minutes. As examples, if there is fatigue after 5 minutes, then the passive phase is 55 minutes; if there is fatigue after 55 minutes, then the passive phase is 5 minutes. In de-conditioned patients, the muscles may fatigue within minutes of the commencement of electrical stimulation and others may be too weak to cycle alone with electrical stimulation at all. In these cases the passive movement will be performed for most of the therapy session. Over time, the patients' muscles will become stronger and more resistant to fatigue allowing the amount of time in passive therapy to reduce. During a one hour therapy session the level of FES applied to the impaired limb is initially increased as the muscles fatigue to attempt to achieve and maintain a given level or speed of exercise, however eventually the FES may reach the maximum desired level (either the maximum that can be tolerated by the patient or the maximum that can be generated by the device.) At this point the muscles of the impaired limb are considered to be fatigued. In order to continue movement of the limb after the muscles tire, FES is reduced or discontinued and passive exercise is initiated. By passively moving the affected limbs by mechanical means afferent neural feedback continues to be delivered into the impaired central nervous system for the entire duration of therapy. Therapy duration is no longer determined by muscle fatigue so a therapeutically effective duration of exercise can be provided at each therapy session. As a result, with prolonged treatment over many weeks or months, individuals with a nervous system injury are able to improve their neurological condition resulting in one or more of improved sensation, improved movement or strength of impaired limbs, improved bladder sensation or control and other general improvements in their neurological condition. These improvements in neurological condition are in addition to improvements in a patient's physical condition arising from the exercise effects of the active therapy. These physical condition improvements include improved muscle bulk in impaired limbs, improved cardiovascular condition, and improvements in blood chemistry such as lipid and testosterone levels.

In the preferred embodiment the therapeutically effective duration of the therapy session is generally one hour. To obtain the best therapeutic effects, therapy sessions should be conducted at least three (3) times per week. The following block diagram depicts the phases of therapy described above:

[image]

The following studies illustrate the neurological effects of the invention.

Study 1

A study conducted by Daniel Becker, Warren M. Grill and John W. McDonald resulted in the demonstration that FES evoked activity can enhance cellular regeneration in patients with a central nervous system injury. The results suggest that controlled electrical activation of the central nervous system can optimize spontaneous regeneration and function recovery in neurological injuries. An article, Functional Electrical Stimulation Helps Replenish Neural Cells in the Adult CNS after Spinal Cord Injury, describing the study is currently under peer review for publication in Proceedings of the National Academy of Sciences.

Study 2

J. W. Donald, C. L. Sadowsky, A. B. Strohl, P. K. Commean, J. Wingert, S. A. Eby, D. L. Damiano and K. T. Bae have reported on a 60 patient cohort study examining FES ergometry in SCI compared to conventional treatment for individuals more that 1.5 years from injury. The authors have reported that FES ergometry was associated with significant improvements in physical integrity and functional recovery. Thigh (quadriceps) muscle mass was increased by an average of 30% while intra/inter-muscular fat was reduced by 44%. Stimulated muscle strength was increased by 78% while relative spasticity was simultaneously reduced by 47%. These effects were specific with no differences observed in non-stimulated muscles. In parallel, the low HDL and testosterone levels and impaired glucose tolerance of controls were normalized in FES treatment subjects. The average 10 point loss of ASIA motor-sensory scores in control subjects over three years was offset in FES treatment subjects with an additional average 38-point observed improvement. FES treatment was associated with a 70% responder rate. The 30% of FES treatment subjects that did not recover function at least did not lose function. ASIA grade conversion rates were 40% in FES treatment subjects compared to 4% in control subjects. The FES treatment group required less antispasmodic drug treatment and a greater percentage of FES treatment subjects were able to discontinue or reduce the dosage of baclofen required to control spasticity. Restorative Therapy, Physical and Functional Recovery in Chronic Spinal Cord Injury: a Cohort Study. Presented as a poster at the American Neurological Association conference, Sep. 25-28, 2005 San Diego, Calif.

It is to be understood that the present disclosure is to be considered only as an example of the principles of the invention. This disclosure is not intended to limit the broad aspect of the invention to the illustrated embodiment.

I claim:

1. A method of rehabilitating a person who has suffered central nervous system damage comprising the steps of: providing exercise equipment capable of exercising a person's limbs; providing functional electrical stimulation to the person's limbs to be exercised in order to operate the exercise equipment; increasing the level of functional electrical stimulation; decreasing a resistance provided by the exercise equipment or providing assistance to maintain an acceptable speed of the exercise equipment as the person's muscles tire; finally completely removing functional electrical stimulation to the person's limbs and providing assistance to maintain an acceptable speed of the exercise equipment; and continuing passive exercise of the person's limbs for a period of time greater than two minutes.

2. The method of claim 1 wherein the step of reducing the level of functional electrical stimulation as the person's muscles tire comprises the step of continuously reducing the level of functional electrical stimulation.

3. The method of claim 1 wherein the step of reducing the level of functional electrical stimulation as the person's muscles tire comprises the step of reducing the level of functional electrical stimulation stepwise.

4. The method of claim 1 wherein the step of reducing the level of functional electrical stimulation as the person's muscles tire comprises the step of reducing the level of functional electrical stimulation to zero.

5. The method of claim 1 wherein the step of providing exercise equipment capable of exercising a person's limbs comprises the step of providing a gate trainer.

6. The method of claim 1 wherein the step of providing exercise equipment capable of exercising a person's limbs comprises the step of providing a stationary bicycle.

7. The method of claim 1 wherein the step of providing exercise equipment capable of exercising a person's limbs comprises the step of providing a stationary bicycle that can be pedaled by the user without being removed from a wheelchair.

8. The method of claim 1 further comprising the step of regenerating a person's damaged central nervous system and allowing the person to regain improved neurological function of areas of the body affected by the neurological impairment.

9. A bicycle for exercising limbs of a paralyzed person comprising: a pair of pedals operable by the paralyzed person; a functional electrical stimulation controller comprising functional electrical stimulation to muscles of the limbs of the paralyzed person in order to operate the pedals wherein the functional electrical stimulation controller is adapted for reducing the level of functional electrical stimulation as the muscles tire; and an electric motor for providing resistance or assistance to the pedals in order to maintain a desired activity level.

10. The bicycle of claim 9 wherein the functional electrical stimulation controller adapted for reducing the level of functional electrical stimulation as the muscles tire is further adapted to provide a continuous decrease in functional electrical stimulation until the muscles are no longer being stimulated.

11. The bicycle of claim 9 wherein the functional electrical stimulation controller adapted for reducing the level of functional electrical stimulation as the muscles tire is further adapted to provide a stepwise decrease in functional electrical stimulation until the muscles are no longer being stimulated.

12. The bicycle of claim 9 wherein the functional electrical stimulation controller adapted for reducing the level of functional electrical stimulation as the muscles tire is further adapted to provide an immediate discontinuance of functional electrical stimulation.

13. The bicycle of claim 9 comprising a seat into which the person is placed in order to operate the pedals.

14. The bicycle of claim 9 comprising a mechanism to allow a wheelchair or other chair to be used with the bicycle and a mechanism to prevent movement of the chair.

15. The bicycle of claim 9 comprising the means to log data regarding the therapy of the patient and transmit that data via a telecommunications link.

16. The bicycle of claim 9 comprising the means to transmit images of the person to a third party and to receive and display the images on the screen.

17. The bicycle of claim 9 comprising the means to generate and display a virtual image of the user using the bicycle in a virtual location.

18. The bicycle of claim 9 comprising a microphone and a microprocessor adapted to receive voice commands from the person and control the bicycle in response thereto.

19. The bicycle of claim 9 comprising a personal computer operating system to allow the person to perform the functions selected from the list consisting of: browsing the Internet, sending email, drafting letters, playing games and tracking personal finances while the person's limbs are being exercised.

20. A gate trainer for exercising limbs of a paralyzed person comprising: a frame; a flywheel mounted on said frame; opposed crank arms attached to said flywheel; a motor connected to said flywheel by a belt or chain; crank arms on both sides of said flywheel; translational motion shafts connected to said crank arms; rollers attached to opposite ends of said translational motion shafts; slots on opposite sides of said frame in which said rollers are trapped; foot support rods and foot supports attached to each of said translational motion shafts; a handrail attached to said frame; a control pad attached to said handrail; and a computer attached to said frame.

21. The gate trainer of claim 20 wherein said foot supports are height-adjustable.
